(19) United States
(12) Patent Application Publication
(10) Pub. No.: US 2013/0120655 A1
(43) Pub. Date: May 16, 2013

(54) METHOD, APPARATUS AND SYSTEM FOR USING BACKCHANNELS FOR CONTROLLING AND CONFIGURING DISPLAYS AND PERIPHERAL DEVICES

(71) Applicant: Gregory Charles Herlein, San Francisco, CA (US)

(72) Inventor: Gregory Charles Herlein, San Francisco, CA (US)

(73) Assignee: THOMSON LICENSING, Issy de Moulineaux (FR)

(21) Appl. No.: 13/812,749

(22) PCT Filed: Jan. 19, 2011
(86) PCT No.: PCT/US2011/000097

§ 371 Date: Jan. 28, 2013

Related U.S. Application Data
(60) Provisional application No. 61/368,364, filed on Jul. 28, 2010.

(51) Int. Cl. H04N 5/44

(52) U.S. Cl. CPC H04N 5/4403
USPC 348/552

(57) ABSTRACT

A method, apparatus and system of the present invention include a controller for identifying an available backchannel and for communicating data to an output device over an available backchannel, such as a secondary bi-directional radio backchannel, the data intended to control or configure the output device or an associated peripheral device in communication with the output device.

### CROSS-REFERENCE TO RELATED APPLICATIONS

This application claims the benefit of U.S. Provisional Application Ser. No. 61/368,364, filed Jul. 28, 2010, which is incorporated by reference herein in its entirety.

### FIELD OF THE INVENTION

The present invention generally relates to the use of available secondary bi-directional radio channels and, more particularly, to a method, apparatus and system for the use of such backchannels for controlling and configuring output devices and associated peripheral devices.

### BACKGROUND OF THE INVENTION

Low power DTV broadcast is a cost-effective solution for venue-based advertising systems (for example, in a store, restaurant or mall). However, the state of the art screens provide no way for the advertising system to know if the screen was powered on, receiving the signal, and on the correct channel. Without this information it is impossible to provide proof to the purchasing agent of the advertisement that the ad was delivered. In addition, there is no means for the screen to communicate diagnostic information to the system.

In addition, the state of the art screens provide no way for the advertising system to obtain data back from a screen device. The broadcast medium is uni-directional towards the screen.

Such control and configuration of displays is solved in current systems by using a real network, either wireless or wired (Ethernet). That solution adds unacceptable cost to a system both in the unit price as well as operational cost of operating a real network.

### SUMMARY OF THE INVENTION

Embodiments of the present invention address the deficiencies of the prior art by providing a method, apparatus and system for using backchannels for controlling and configuring output devices, such as displays and associated peripheral devices.

New low power digital TV broadcast systems use a secondary bi-directional radio channel to adhere to FCC rules regarding power levels. In one embodiment of the present invention, such an available backchannel is used to also provide a control channel for centralized command of output devices, such as display devices, within range of the broadcast.

In an alternate embodiment of the present invention, such a backchannel is used to send low bit rate peripheral user interface information to an advertising system to, for example, configure components of an advertising system.

More specifically, in one embodiment of the present invention, a method for communicating control and configuration information using an available low power digital television backchannel includes identifying an available low power digital television backchannel and communicating data to an output device using the identified backchannel, the data intended to control or configure the output device or an associated peripheral device in communication with the output device.

In an alternate embodiment of the present invention, an apparatus for communicating control and configuration information using an available low power digital television backchannel includes a memory for storing program routines and data and a processor for executing the program routines. The processor, when executing the program routines is configured to perform the steps of identifying an available low power digital television backchannel and communicating data to an output device using the identified backchannel, the data intended to control or configure the output device or an associated peripheral device in communication with the output device.

In an alternate embodiment of the present invention, a system for communicating control and configuration information using an available low power digital television backchannel includes a virtual network manager for managing communication, data, and the components of the system, a set-top box for connecting an output device to a source of content including the virtual network manager, a transmitter for providing communication between the set-top box and a receiver, a receiver for receiving a communication from the transmitter and providing such communication to an output device and an output device for rendering content. In the embodiment of the present invention the virtual network manager identifies an available low power digital television backchannel and communicates data to the output device using the identified backchannel, the data intended to control or configure the output device or an associated peripheral device in communication with the output device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of system for using a secondary bi-directional radio channel for controlling and configuring output devices and associated peripheral devices in accordance with an embodiment of the present invention;

FIG. 2 depicts a high level block diagram of a control device suitable for use in the system of FIG. 1 for using a secondary bi-directional radio channel for controlling and configuring output devices and associated peripheral devices in accordance with an embodiment of the present invention; and

FIG. 3 depicts a flow diagram of a method for using a secondary bi-directional radio channel (backchannel) for controlling and configuring output devices and associated peripheral devices in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for using a backchannel, for example a secondary bi-directional radio channel, for controlling and configuring output devices and associated peripheral devices. Although the present invention will be described primarily within the context of a retail advertising network environment and the control and configuration of display devices, the specific embodiments of the present invention should not be treated as limiting the scope of the invention. It will be appreciated by those skilled in the art and informed by the teachings of the present invention that the concepts of the present invention can be advantageously applied in any communications or network environment for the control and configuration of other output devices such as audio output devices and the like.

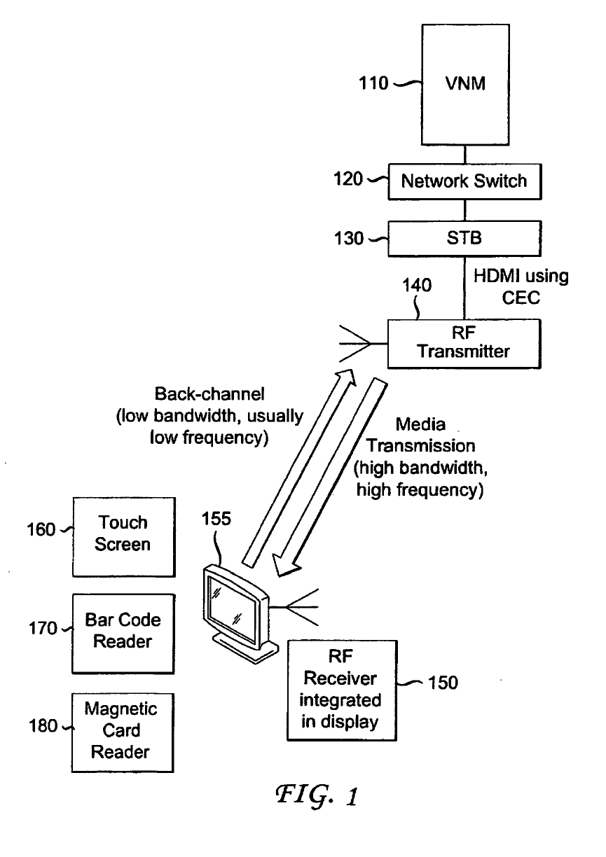

FIG. 1 depicts a high level block diagram of a system for using a secondary bi-directional radio backchannel for controlling and configuring displays and peripheral devices in accordance with an embodiment of the present invention. The embodiment of FIG. 1 includes a virtual network manager (VNM) 110, a network switch 120, a set top box (STB) 130, an RF transmitter 140, and an RF receiver 150 integrated into a display 155. The system of FIG. 1 further includes peripheral devices and applications such as a touch screen application 160, a bar code reader 170 and a magnetic card reader 180. Such peripheral devices and applications c an also be controlled and configured in accordance with various embodiments of the present invention as described herein.

Low-power digital TV systems that use certain spectrum bandwidth are required by the FCC to provide a feedback loop to control the transmit power of the system. Such control can be accomplished using a low-bit rate backchannel. However, even systems that are not required to have such a low bit-rate backchannel may choose to do so. The present invention uses an inventive low-power, low bit-rate bidirectional system to, at least in part, address the deficiencies of the prior art as described above.

More specifically, in one embodiment of the present invention, a control device of the present invention, for example the VNM 110 of FIG. 1, uses a backchannel, illustratively a secondary bi-directional radio channel, to send data such as control commands and configuration data to receiving units, such as the RF receiver 150 of FIG. 1. That is, in the embodiment of FIG. 1, the VNM 110 communicates control/configuration data through the network switch 120, to the STB 130, to the RF transmitter 140 and ultimately to the RF receiver 150, illustratively integrated into the display 155. In one embodiment of the present invention, the receiver 150 acknowledges and processes the received data. As depicted in FIG. 1, the RF transmitter 140 and RF receiver 150 pair provide both, a forward high frequency, high bandwidth channel for typical communication such as media transmission and a low bandwidth backchannel to be used in accordance with concepts of the present invention as described herein. In various embodiments of the present invention, at least the following control commands are supported:
Report health state of system
Change channel to specific digital TV channel
Report Channel
Power down to standby
Power up

In one embodiment of the present invention, the Device Group Control Protocol (as described in co-pending patent application Ser. No. 12/450,564, attorney docket number PU070071, which is herein incorporated by reference in its entirety) is used to support control of groups of devices such as displays. In this context the control messages are broadcast to all devices over a common channel (instead of using multicast IP). Devices assigned to a group would process the received data/command.

Generally, the various embodiments of the present invention use standard low power RF broadcast systems/channels to put the control over display and peripheral device functionality, for example channel changes or configuration capabilities, at the disposal of a user. In accordance with one embodiment of the present invention, that control or configuration ability is centralized using a backchannel that would otherwise be used only for FCC compliance reasons.

Typically, such FCC compliant back-channel data is used only for sharing signal strength data back to the transmitter to allow adjustment to stay within FCC limitations. Embodiments of the invention, however, enable an attached device to be controlled or configured using data or information communicated using an available backchannel. In one simple implementation, control/configuration data is communicated over a network to a STB such as the STB 130 of FIG. 1, where the control/configuration data is communicated to an RF transmitter using, for example, an RS232 port. The control/configuration data is then communicated over the backchannel to an RF receiver where it is communicated, for example, via the RS232 port to a display or peripheral device.

In the embodiment of FIG. 1, control/configuration data is sent over an RF network to the STB 130 where it is sent out to the RF transmitter 140 using a consumer electronics control (CEC) line on a High Definition Multimedia Interface (HDMI) port. The control data/command is then carried over the backchannel to the RF receiver 150 where it is communicated from the CEC line on the HDMI port to the display 155 or peripheral device 160, 170, 180 to be controlled or configured.

Although in the embodiment of FIG. 1, the receiver 150 is depicted as an integrated component of the display 155, in alternate embodiments of the present invention, the receiver 150 can comprise a separate component.

As previously described, the concepts of the present invention can be used to control peripheral devices associated with or connected to a display device. For example, in an alternate embodiment of the present invention, a control/configuration system of the present invention as described above can implement a back channel to enable display devices to provide communication between a system controller and peripheral devices in communication with the display devices. In such embodiments of the present invention, at least the following peripheral devices and functionalities are supported:
Touch screen touch coordinates
Card reader
Bar code scanner

Such embodiments of the present invention are related to the Applicant's co-pending application Ser. No. 12/736122, attorney docket number PU080034, which is herein incorporated by reference in its entirety. In the invention of PU080034, low bit-rate peripheral devices were coupled to a playback device using the CEC channel within HDMI. That invention was directed at least in part to solving a problem of the existence of extra cables for completing such communication and reduced the cost of such systems. Embodiments of the present invention provide the same kind of functionality in an end system but does so over an available backchannel that otherwise would provide no such options.

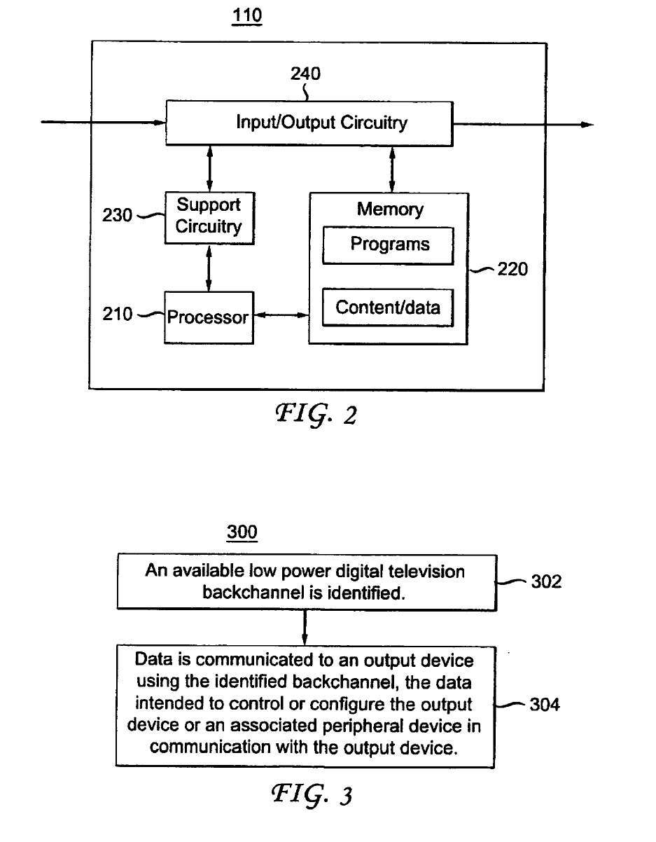

FIG. 2 depicts a high level block diagram of a virtual network manager 110 suitable for use in the system of FIG. 1 for using a backchannel for controlling and configuring displays and peripheral devices in accordance with an embodiment of the present invention. More specifically, the virtual network manager 110 of FIG. 2 illustratively comprises a processor 210 as well as a memory 220 for storing control programs, file information, stored media and the like. The virtual network manager 110 cooperates with conventional support circuitry 230 such as power supplies, clock circuits, cache memory and the like as well as circuits that assist in executing the software routines stored in the memory 220. As such, it is contemplated that some of the process steps discussed herein as software processes may be implemented within hardware, for example, as circuitry that cooperates with the virtual network manager 110 to perform various steps. The virtual network manager 110 also contains input-output circuitry 240 that forms an interface between various functional elements communicating with the virtual network manager 110 such as a set-top box, a network switch and the like.

Again, although the virtual network manager 110 of FIG. 2 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

FIG. 3 depicts a flow diagram of a method 300 for using a backchannel for controlling and configuring displays and peripheral devices in accordance with an embodiment of the present invention. The method 300 begins at step 302 during which an available backchannel is identified. The method 300 then proceeds to step 304.

At step 304, data is communicated to a display device using an identified backchannel, the data intended to control or configure the display device or a peripheral device in communication with said display device. The method 300 can then be exited.

Having described various embodiments for a method, apparatus and system for providing a backchannel for controlling and configuring displays and peripheral devices (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method comprising the steps of:
identifying an available low power digital television backchannel; and
communicating data to an output device using the identified backchannel, the data intended to control or configure the output device or an associated peripheral device in communication with the output device.

2. The method of claim 1 wherein said low power digital television backchannel is a secondary bi-directional radio channel.

3. The method of claim 1, wherein said output device comprises a display device.

4. The method of claim 1, wherein said peripheral device comprises at least one of a touch screen device, a card reader and a bar code scanner.

5. The method of claim 1, wherein said control data is intended to cause at least one of the reporting of the health of the output device or a system including the output device, change a content channel, identify an active channel, power down an output device to standby and power up an output device.

6. An apparatus for communicating control and configuration information using an available low power digital television backchannel, comprising:
a memory for storing program routines and data; and
a processor for executing said program routines, said processor, when executing said program routines, configured to perform the steps of:
identifying an available low power digital television backchannel; and
communicating data to an output device using the identified backchannel, the data intended to control or configure the output device or an associated peripheral device in communication with the output device.

7. The apparatus of claim 6, wherein said apparatus comprises a virtual network manager in a retail advertising environment.

8. The apparatus of claim 6, wherein said low power digital television backchannel is a secondary bi-directional radio channel.

9. The apparatus of claim 6, wherein said output device comprises a display device.

10. The apparatus of claim 6, wherein said peripheral device comprises at least one of a touch screen device, a card reader and a bar code scanner.

11. The apparatus of claim 6, wherein said control data is intended to cause at least one of the reporting of the health of the output device or a system including the output device, change a content channel, identify an active channel, power down an output device to standby and power up an output device.

12. A system for communicating control and configuration information using an available low power digital television backchannel, comprising:
a virtual network manager for managing communication, data, and the components of the system;
a set-top box for connecting an output device to a source of content including said virtual network manager;
a transmitter for providing communication between the set-top box and a receiver;
a receiver for receiving a communication from said transmitter and providing such communication to an output device; and
an output device for rendering content;
wherein said virtual network manager identifies an available low power digital television backchannel and communicates data to the output device using the identified backchannel, the data intended to control or configure the output device or an associated peripheral device in communication with the output device.

13. The system of claim 12, further comprising a network switch for directing communications to a specific output device.

14. The system of claim 12, wherein said receiver is integrated into said output device.

15. The system of claim 12, wherein said transmitter comprises a radio frequency transmitter, said receiver comprises a radio frequency receiver and said low power digital television backchannel comprises a secondary bi-directional radio channel.

16. The system of claim 12, wherein said output device comprises a display device.

17. The system of claim 12, wherein said peripheral device comprises at least one of a touch screen device, a card reader and a bar code scanner.

18. The system of claim 12, wherein said transmitter and receiver provide both a high frequency, high bandwidth communication channel and the low power digital television backchannel.
